(19) United States
(12) Patent Application Publication
(10) Pub. No.: US 2015/0286027 A1
(43) Pub. Date: Oct. 8, 2015

(54) OPTICAL LENS BARREL AND OPTICAL LENS MODULE HAVING THE SAME

(71) Applicant: Genius Electronic Optical Co., Ltd., Science Park (TW)

(72) Inventors: Min-Wei Lee, Science Park (TW); Chia-Ming Lin, Science Park (TW)

(21) Appl. No.: 14/454,924

(22) Filed: Aug. 8, 2014

(30) Foreign Application Priority Data
Apr. 3, 2014 (TW) 103112560

(51) Int. Cl. G02B 7/02

(52) U.S. Cl. CPC G02B 7/021

(57) ABSTRACT

An optical lens module includes a barrel holder, an optical lens barrel, a first thread, a second thread and a plurality of engaging protrusions. The first thread is formed on one of the barrel holder and the optical lens barrel. The second thread is formed on the other one of the barrel holder and the optical lens barrel. The engaging protrusions extend from the root of the first thread for contact with the crest of the second thread. Each of the engaging protrusions has an end surface disposed between the crest and the root of the first thread. A clearance is formed between the crest of the first thread and the root of the second thread and between the root of the first thread and the crest of the second thread.

### CROSS-REFERENCE TO RELATED APPLICATION

This application claims priority of Taiwanese Patent Application No. 103112560, filed on Apr. 3, 2014, the entire disclosure of which is hereby incorporated by reference.

### BACKGROUND OF THE INVENTION

1. Field of the Invention

This invention relates to an optical lens module, more particularly to an optical lens barrel of an optical lens module.

2. Description of the Related Art

Referring to FIG. 1, a conventional optical lens module includes a barrel holder 10, an optical lens barrel 11 and a plurality of lenses 12 accommodated in the optical lens barrel 11. The barrel holder 10 includes a holder wall 102 and an internal thread 101 formed on the holder wall 102. The optical lens barrel 11 includes a barrel wall 112, and an external thread 111 formed on the barrel wall 112 and adapted to engage the internal thread 101 of the barrel holder 10.

During manufacture, the external thread 111 and the barrel wall 112 of the optical lens barrel 11 are formed in a mold (not shown) by a molding process.

During an assembling process, a frictional force is generated by contact between the internal and external threads 101, 111 so as to provide a sufficient torque to interconnect the barrel holder 10 and the optical lens barrel 11. When the internal and external threads 101, 111 are interengaged in a tight fit manner, a relatively large frictional force is generated so as to provide a relatively large torque. By contrast, when interengaged in a loose fit manner, a relatively small frictional force is generated so as to provide a relatively small torque.

Therefore, a maker may change the shape of the mold cavity corresponding to the external thread 111 to adjust to a desired torque to meet actual requirements. However, this requires a relatively large area of the mold to be adjusted and therefore is relatively time-consuming and inconvenient to the maker.

### SUMMARY OF THE INVENTION

Therefore, the object of the present invention is to provide an optical lens barrel and optical lens module that can overcome the aforesaid drawback of the prior art.

According to one aspect of the present invention, there is provided an optical lens barrel that includes a barrel wall, a thread and a plurality of spaced-apart engaging protrusions. The barrel wall extends along an axial direction. The thread is formed on the barrel wall and has a plurality of turns, a root and a crest extending helically along the axial direction. The engaging protrusions extend frcm the root of the thread. Each of the engaging protrusions has an end surface disposed between the crest and the root of the thread.

According to another aspect of the present invention, there is provided an optical lens module that includes a barrel holder, an optical lens barrel, a plurality of lenses, a first thread, a second thread and a plurality of spaced-apart engaging protrusions. The barrel holder includes a holder wall. The optical lens barrel includes a barrel wall extending along an axial direction. The lenses are accomodated in the optical lens barrel. The first thread is formed on one of the holder wall and the barrel wall, and has a plurality of turns, a root and a crest extending helically along the axial direction. The second thread is formed on the other one of the holder wall and the barrel wall, and has a plurality of turns, a root and a crest extending helically along the axial direction. The engaging protrusions extend from the root of the first thread for contact with the crest of the second thread; and each of the engaging protrusions has an end surface disposed between the crest and the root of the first thread. One of the first and second threads is an external thread, and the other one of the first and second threads is an internal thread. A clearance is forced between the crest of the first thread and the root of the second thread, and between the root of the first thread and the crest of the second thread.

According to yet another aspect of the present invention, there is provided an optical lens barrel that is adapted to be threaded to a barrel holder. The barrel holder includes a holder wall formed with a thread. The optical lens barrel includes a barrel wall, a thread and a plurality of spaced-apart engaging protrusions. The barrel wall extends along an axial direction. The thread is formed on the barrel wall and is adapted to engage the thread of the barrel holder. The thread of the optical lens barrel has a plurality of turns, a root and a crest extending helically along the axial direction. The engaging protrusions extend from the thread of the optical lens barrel and are adapted for contact with the thread of the barrel holder. Each of the engaging protrusions has an end surface disposed between the crest and the root of the thread or the optical lens barrel.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a sectional view of a conventional optical lens module;

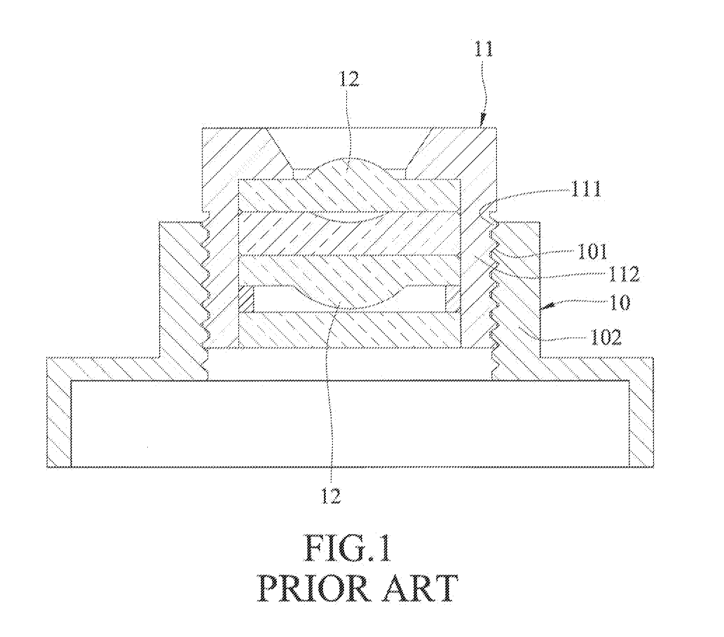

FIG. 2 is a sectional view of the preferred embodiment of an optical lens module according to this invention;

FIG. 3 is a fragmentary sectional view of the preferred embodiment;

FIG. 4 is a schematic view showing an optical lens barrel of the preferred embodiment of an optical lens module; and

FIG. 5 is a top view of FIG. 4.

### DETAILED DESCRIPTION OF THE PREFERRED EMBODIMENT

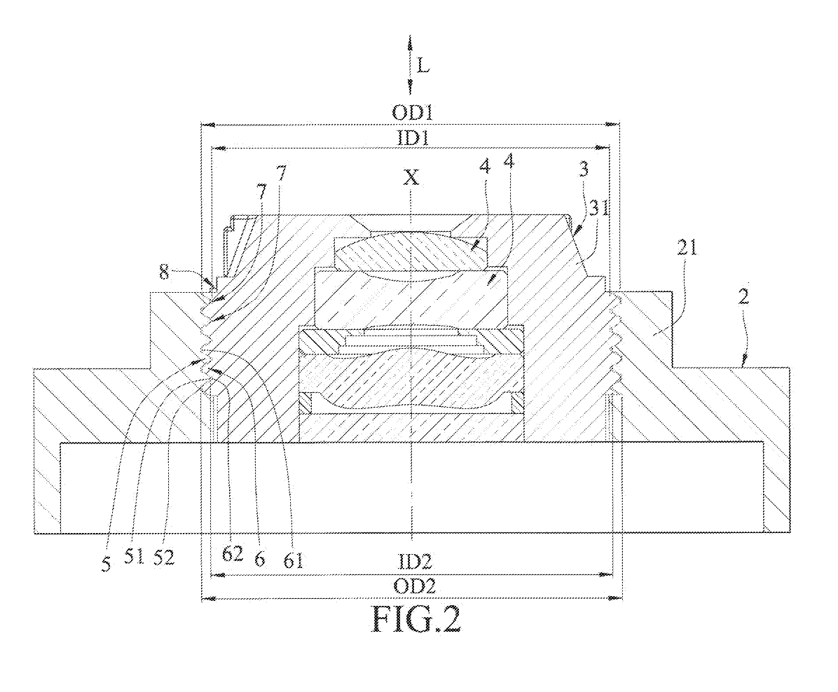

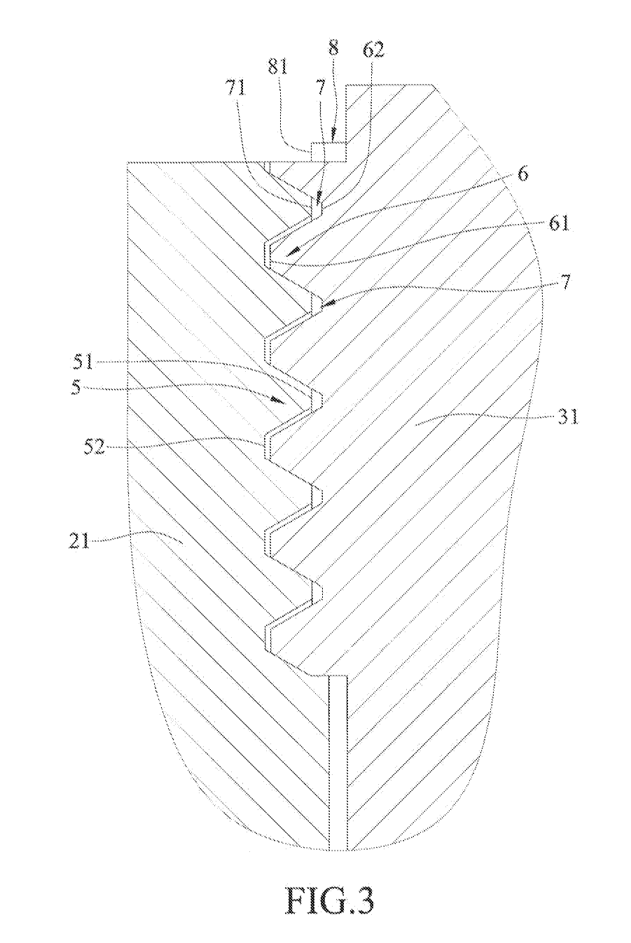

Referring to FIGS. 2, 3 and 4, the preferred embodiment of an optical lens module according to the present invention is shown to include a barrel holder 2, an optical lens barrel 3, a plurality of lenses 4, a first thread 6, a second thread 5 and a plurality of spaced-apart engaging protrusions 7.

The barrel holder 2 includes a holder wall 21. The optical lens barrel 3 includes a barrel wall 31 extending along an axial direction (L). The lenses 4 are accommodated in the optical lens barrel 3.

The first thread 6 is formed on the barrel wall 31, and has a plurality of turns, a root 62 and a crest 61 extending helically along the axial direction (L).

The second thread 5 is formed on the holder wall 21, and has a plurality of turns, a root 52 and a crest 51 extending helically along the axial direction (L).

One of the first and second threads 6, 5 is an external thread, and the other one of the first and second threads 6, 5 is an internal thread. A clearance is formed between the crest 61 of the first thread 6 and the root 52 of the second thread 5, and between the root 62 of the first thread 6 and the crest 51 of the second thread 5 (i.e., the first and the second threads 6, 5 are engaged to each other in a loose fit manner).

In this preferred embodiment, the first thread 6 is an external thread and the second thread 5 is an internal thread. In an alternative embodiment, the external thread is formed on the barrel holder 2, and the internal thread is formed on the optical lens barrel 3. In such case, along a radial direction orthogonal to the axial direction (L), the crest 51 of the second thread 5 defines an inner diameter (ID2), the root 52 of the second thread 5 defines an outer diameter (OD2), the crest 61 of the first thread 6 defines an outer diameter (OD1), and the root 62 of the first thread 6 defines an inner diameter (ID1). The outer diameter (OD2) of the root 52 of the second thread 5 is greater than the outer diameter (OD1) of the crest 61 of the first thread 6. The inner diameter (ID2) of the crest 51 of the second thread 5 is greater than the inner diameter (ID1) of the root 62 of the first thread 6. To be more specific, the width of the clearance between the roof 52 of the second thread 5 and the crest 61 of the first thread 6 ranges from 0.01 mm to 0.05 mm. The width of the clearance between of the crest 51 of the second thread 5 and the root 62 of the first thread 6 also ranges from 0.01 mm to 0.05 mm. The first thread 6 further has an inclined surface between the crest 61 and the root 62. The second thread 5 further has an inclined surface between the crest 51 and the root 52. The clearance between the inclined surfaces of the second thread 5 and first thread 6 also ranges from 0.01 mm to 0.05 mm.

The engaging protrusions 7 extend from the root 62 of the first thread 6 for contact with the crest 51 of the second thread 5. Each of the engaging protrusions 7 has an end surface 71 disposed between the crest 61 and the root 62 of the first thread 6. To be specific, the crest 51 of the second thread 5 abuts against the end surface 71 of the engaging protrusions 7 so that the first and second threads 6, 5 are threaded to each other.

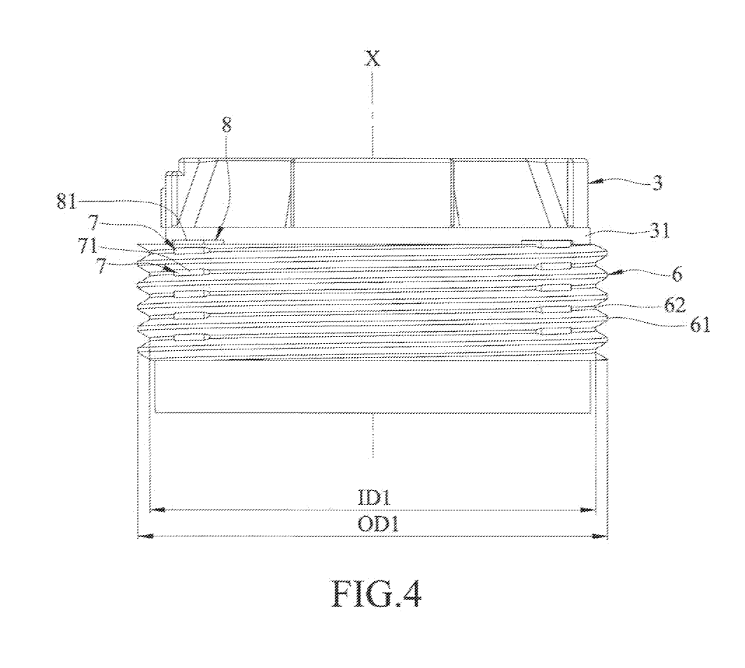

In this preferred embodiment, the number of the engaging protrusions 7 disposed on the root 62 of the first thread 6 in each of the turns of the first thread 6 is three (only two are visible in FIG. 4). The engaging protrusions 7 are arranged in three rows extending along the axial direction (L) and being angularly equidistant. The end surface 71 of each of the engaging protrusions 7 is curved, and is concentric with the root 62 of the first thread 6. In this embodiment, along the radial direction, the curved end surface 71 of each of the engaging protrusions 7 defines a diameter that has the same value as the inner diameter (ID2) of the crest 51 of the second thread 5 (i.e., the end surface 71 of each of the engaging protrusions 7 is in intimate contact with the crest 51 of the second thread 5.

It should be noted that the number of the engaging protrusions 7 disposed on the root 62 of the first thread 6 in each of the turns of the first thread 6 is not limited to three and may be varied based on actual requirements (for example, the number can be one, two, four, etc). Moreover, the engaging protrusions 7 in each of the turns of the first thread 6 may also be angularly non-equidistant, the engaging protrusions 7 may not arranged in rows extending along the axial direction, and the end surface 71 of each of the engaging protrusions 7 may not be curved (for example, may be spheric, flat, etc) based on actual requirements and therefore should not be taken as limitations to this invention.

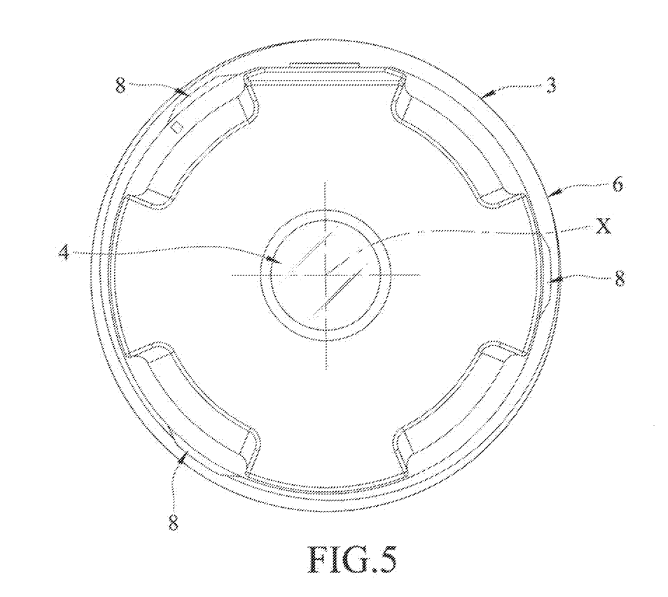

Referring to FIGS. 2 to 5, in this preferred embodiment, the optical lens module further includes three measurement protrusions 8 extending from the first thread 6, aligned respectively with the three rows of the engaging protrusions 7, and each having an end surface 81 aligned with the end surfaces 71 of the corresponding row of the engaging protrusions 7 such that, when the first thread 6 is viewed along the axial direction (L), the measuring protrusions 8 are visible.

The end surface 81 of each of the measurement protrusions 8 is spaced apart from a central axis (X) of the optical lens barrel 3 by a distance (i.e., curvature radius) the same as that of the end surface 71 of each of the engaging protrusions 7. In this preferred embodiment, the measurement protrusions 8 are disposed on a top end of the first thread 6 (i.e., at the object side of the optical lens barrel 3). However, in a variation of this embodiment, the measurement protrusions 8 may be disposed on a bottom end of the first thread 6 (i.e., at the image side of the optical lens barrel 3). Moreover, it should be noted that number of the measurement protrusions 8 is not limited to three and may be varied based on actual requirement (for example, the number can be one, two, four, etc).

During manufacture, the optical lens barrel 3, the first thread 6, the engaging protrusions 7 and the measurement protrusions 8 are formed as one-piece, more specifically, formed in a mold (not shown) by injection molding. It is worth noting that the shape of each turn of the crest 61 of the first thread 6 (which is an external thread in this embodiment) may be designed as an ellipse instead of a circle (i.e., the outer diameter (OD1) of the crest 61 of the first thread 6 is not a constant) to overcome a flash issue described in U.S. Patent Application Publication No. 2013/0182342 A1, which is incorporated fully herein by reference.

During an assembling process, a frictional force is generated by contact between the engaging protrusions 7 and the crest 51 of the second thread 5 so as to provide a desired torque to interconnect the barrel holder 2 and the optical lens barrel 3.

To conclude, the optical lens module of this disclosure is advantageous for the following reasons:

(1) It is more convenient and time-saving for a maker to adjust different torques since the maker only needs to adjust the shape of portions of the mold cavity corresponding to the engaging protrusions 7 (instead of the whole first thread 6).

(2) By virtue of the loose fit engagement between the first and second threads 6, 5, the manufacturing precision of the first thread 6 is not highly demanded. Moreover, the first thread 6 does not rub against the second thread 5 so that powder pollution is diminished.

(3) Since the engaging protrusions 7 are arranged in rows along the axial direction (L), it is convenient for the maker to adjust the shape of portions of the mold cavity corresponding to the engaging protrusions 7.

(4) The maker can obtain the curvature radius of the end surfaces 71 of the engaging protrusions 7 by measuring the curvature radius of the end surfaces 81 of the measurement protrusions 8. Since the measurement protrusions 8 are visible when viewed along the axial direction (L), they are easier to measure than the engaging protrusions 7 (which are partly shielded by the first thread 6) and therefore the manufacturing efficiency can be improved.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An optical lens barrel comprising:
a barrel wall extending along an axial direction;
a thread formed on said barrel wall and having a plurality of turns, a root and a crest that extend helically along the axial direction; and
a plurality of spaced-apart engaging protrusions extending from said root of said thread, each of said engaging protrusions having an end surface disposed between said crest and said root of said thread.

2. The optical lens barrel as claimed in claim 1, further comprising a measurement protrusion that extends from said barrel wall and that has an end surface aligned with said end surface of one of said engaging protrusions along the axial direction such that, when said thread is viewed along the axial direction, said measuring protrusion is visible.

3. The optical lens barrel as claimed in claim 1, wherein number of said engaging protrusions disposed on said root of said thread in each of said turns of said thread is three.

4. The optical lens barrel as claimed in claim 3, wherein said engaging protrusions are arranged in three rows extending along the axial direction and being angularly equidistant.

5. The optical lens barrel as claimed in claim 1, wherein said end surface of each of said engaging protrusions is curved, and is concentric with said root of said thread.

6. An optical lens module comprising:
a barrel holder including a holder wall;
an optical lens barrel including a barrel wall extending along an axial direction;
a plurality of lenses accommodated in said optical lens barrel;
a first thread formed on one of said holder wall and said barrel wall and having a plurality of turns, a root and a crest that extend helically along the axial direction;
a second thread formed on the other one of said holder wall and said barrel wall and having a plurality of turns, a root and a crest that extend helically along the axial direction; and
a plurality of spaced-apart engaging protrusions extending from said root of said first thread for contact with said crest of said second thread, each of said engaging protrusions having an end surface disposed between said crest and said root of said first thread;
wherein one of said first and second threads is an external thread, and the other one of said first and second threads is an internal thread;
wherein a clearance is formed between said crest of said first thread and said root of said second thread and between said root of said first thread and said crest of said second thread.

7. The optical lens module as claimed in claim 6, further comprising a measurement protrusion that extends from said first thread and that has an end surface aligned with said end surface of one of said engaging protrusions such that, when said first thread is viewed along the axial direction, said measuring protrusion is visible.

8. The optical lens module as claimed in claim 6, wherein number of said engaging protrusions disposed on said root of said first thread in each of said turns of said first thread is three.

9. The optical lens module as claimed in claim 8, wherein said engaging protrusions are arranged in three rows extending along the axial direction and being angularly equidistant.

10. The optical lens module as claimed in claim 6, wherein said end surface of each of said engaging protrusions is curved, and is concentric with said root of said first thread.

11. An optical lens barrel adapted to be threaded to a barrel holder, the barrel holder including a holder wall formed with a thread, said optical lens barrel comprising:
a barrel wall extending along an axial direction;
a thread formed on said barrel wall and adapted to engage the thread of the barrel holder, said thread of said optical lens barrel having a plurality of turns, a root and a crest that extend helically along the axial direction; and
a plurality of spaced-apart engaging protrusions extending from said thread of said optical lens barrel and adapted for contact with the thread of the barrel holder, each of said engaging protrusions having an end surface disposed between said crest and said root of said thread of said optical lens barrel.

12. The optical lens barrel as claimed in claim 11, further comprising a measurement protrusion that extends from said barrel wall and that has an end surface aligned with said end surface of one of said engaging protrusions along the axial direction such that, when said thread is viewed along the axial direction, said measuring protrusion is visible.

13. The optical lens barrel as claimed in claim 11, wherein number of said engaging protrusions disposed on said root of said thread in each of said turns of said thread is three.

14. The optical lens barrel as claimed in claim 13, wherein said engaging protrusions are arranged in three rows extending along the axial direction and being angularly equidistant.

15. The optical lens barrel as claimed in claim 11, wherein said end surface of each of said engaging protrusions is curved, and is concentric with said root of said thread.
